(19) United States
(12) Patent Application Publication
(10) Pub. No.: US 2026/0218679 A1
(43) Pub. Date: Jul. 30, 2026

(54) WIND POWER PLANT FOR GENERATING ENERGY

(71) Applicant: Andreas Nuske, Donaueschingen (DE)

(72) Inventors: Andreas NUSKE, Donaueschingen (DE); Edmund SCHIESSLE, Schorndorf (DE)

(21) Appl. No.: 19/146,144

(22) PCT Filed: Jan. 3, 2024
(86) PCT No.: PCT/EP2024/050106

§ 371 Date: Jul. 7, 2025

(30) Foreign Application Priority Data
Jan. 4, 2023 (DE) 10 2023 100 176.0

(51) Int. Cl. F03D 5/00; F03D 9/32; F03D 13/20

(52) U.S. Cl. CPC F03D 5/015; F03D 9/322; F03D 13/20; F05B 2240/922

(57) ABSTRACT

The invention relates to an airborne wind energy system with a substantial, integrated safety and security architecture which, in emergency situations (crash scenario), controls the wind energy system as a whole or the installed individual components and safely brings same directly back to the ground station, which takes into consideration a controllable kite construction for high wind layers in order to synergistically and substantially increase the lift force, which is normally generated solely by the gas-filled airship (climbing balloon or zeppelin), in order to maximize the generation of power with the aid of the wind converter while simultaneously ensuring the necessary stability of the entire system in the air.

### INTRODUCTION

The purpose of the present invention is to convert a wind power plant (WKA) driven by means of altitude wind (>500 m to 15.000 m) with an energy recovery of at least >0.5 Mega-Watt power. In particular, the construction according to the invention is intended to be achieved by the design according to the invention:

a substantial safety and safety architecture as preventive measures against fall risks, accident risks as well as damage minimization measures, in the case of a weight to be expected, but entirely possible or latent fall scenario, in order thereby to achieve a regulatory approval for primary project realizations on the land (=in particular in particular).

A significant increase in the buoyancy force by means of synergetically acting partial solutions, in order thereby to achieve a substantially higher, a more efficient and more uniform and permanent energy recovery with the aid of the wind force, and in principle a significantly better stabilization of the overall system, even under extremely demanding and partially chaotically acting weather conditions have to act.

It is conspicuous that 4-dimensional wind turbines (=WKAs) known from the prior art (=WKAs), which are not fastened directly to the ground (=in particular in particular) or to or via floating pontoons (=offshore), which use the wind power in a flying or floating manner as energy generation, but i.d R represents solution or exemplary embodiments which, in principle, focus on design solutions or inventions, the centre of gravity of which mainly relates to embodiments of various wind reduction systems (z. B Dararius/Sonius rotors or similar constructions) without the above Aspects must be taken into account. In particular, the fact that WKAs, depending on the embodiment of the missile, is solid to the side by the wind force and theoretically could be pressed in the case of very strong wind up to the ground plane; similar to a water buoy which is pressed downwards by the flow and wave path of the water. Even missiles which are constructed like an aircraft or zeptelin are also forced away from the wind force and moreover generate an inherent problem in the hovering phase at a low altitude, since there can be uncontrollable vortex winch, in particular if the wind converter with generator is located on or directly on the missile and in which. The dynamics prevailing in this case (e.g. different air resistances [=cW]) result in different gravity differences and in order to compensate for these in a manner corresponding to homeostasis or the resulting differences would be a technical master power. In principle, however, the question arises as to whether a construct in principle still has a reasonable climbing performance, since the climbing capacity of purely gas-filled WKAs, in relation to the energy recovery, is extremely modest in nature.

Lift forces due to gas-filled airships allow only small wind power generation plants, since, with increasing wind strength, the acting force on the rotor blades increases disproportionately and consequently the vertical deflection of the overall construction (=GK) in windless air layers would result.

Furthermore, there is a physical and economic interfood conflict between the structurally related buoyancy force (gas lift vs. Total weight of a large wind power plant driven by vertical wind) and the maximum desired energy recovery, i.e. The larger the corresponding rotor surface, the heavier the overall construct—additional, weight-enhancing stabilizing structures are thereby necessary. Therefore, the relatively low lift force with flying Hwks HWK plant inventions, equipped exclusively with an airship, is basically the limiting factor. This obvious and inherent basic problem could, of course, be avoided if, in this regard, the H-GWKA would be attached to a helicopter (limiting factor of oxygen content in air) operated with fossil fuels, in order to benefit accordingly from the height winches; However, the energy yield would probably be lower than the energy of the helicopter used for this, or the one/more oversized drone/s would also be a construction from the ground, with the aid of a type of “lantern rod” on which the energy harvesting apparatus is hanging, since the correct design height and the technical complexity associated therewith would be inconsistent with the actual approach.

The present invention provides a wind turbine. The wind turbine comprises:
a ground station, a tether, a wind converter, and an airship, wherein the airship is connected via the tether to a bottom plate of a ground station,
wherein the wind converter has a rotor and a generator connected to the rotor, wherein the airship has a flight-initiation apparatus, and wherein the wind converter is arranged on the holding cable in the region between the floor plate and the airship, preferably below the airship. The wind turbine according to the invention further comprises a safety and securing device, which is integrated in the region starting from the base plate up to the airship.

The wind power plant (WKA) according to the invention comprises exclusively flying tandem systems comprising an airship and a flight initiation apparatus which ensure that the H-GWKA can develop a maximum lift force and thus can dimension the power generation apparatus (wind turbine) in such a way that the power potential thereof is more than competitive with existing WKAs, which use the acting wind force for generating energy (=harvesting) from the ground or from the sea surface. Interestingly, in most cases an extremely inconspicuous and clearly below-estimated and blanked-out factor, which opposes the buoyancy force in the case of four-dimensional WKAs, is ignored, namely the stable holding cable, which can weigh through 1 kg and more/running meters and at a desired flight height of, for example,
10. 000 m alone would weigh the tether 10,000 kg and more and, at such a weight, would automatically design a construction with a tether,
which is fastened to the tip of a zept-like airship, pull the tip significantly downwards and thus move the integrated wind converter out of the optimum flight position (LUV). This could, of course, be avoided if a further cable would be attached to such a construction that is best equally heavy to successfully counteract a predominant imbalance of the overall system; However, if the second or even a plurality of ropes (buoyancy force of the system decreases with each further tether), the potential danger exists that the cables, in particular in the case of unstable weather conditions, can twist and thus could endanger the overall system, or the cables are spread apart to such an extent that the area fraction would increase in a massive manner and would therefore be more likely to oppose a WKAs approved on the land, on the other hand.

For a realistic, authorities approved by authorities, in particular as a competitive alternative to existing wind power plants constructed in a classical manner on the ground (in particular) or on a floating pontoon (offshore), it is indispensable that the wind power installation takes into account preventive measures against emergency situations; entirely according to the Motto: “whoes up, must comb down”. It is fundamentally impossible to construct a mechanical, flying or floating wind turbine in such a way that its probability of absolute integrity is 100% (complete exclusion of a residual risk) and therefore the basic invention is intended to contribute to the fact that a latent residual risk of an emergency situation (e.g. fall scenario) remains risk-free for Leb and life.

Furthermore, it is obvious that floating or flying in particular wind power plants always require approval authorities and precisely in the evaluation of a latent residual risk with respect to. Leb and life, a release without a convincing safety concept can be undone; in contrast to this, an approval for an off-shore operation that can be implemented at any time is significantly easier for the underlying idea. The underlying idea should in particular optimize the coupling energy generation vs. direct energy use (e.g. hydrogen production directly on industrial installations, energy supply directly to cities without long power line traces).

In our search, it has been found that this significant point has not yet been taken into consideration until now and specifically in connection with extremely cost-intensive and massive environmental destruction in the removal of line networks or line paths through closed or planned offshore wind turbines, the underlying invention is intended to represent a solution to be future.

In addition, the underlying invention should enhance a realistic start-up in heavy wind regions remote from the ground, the inherent buoyancy force of which, as a result of the use of a flight initiation apparatus preferably located directly on the airship, for example in the form of a draw kite. It will be appreciated that some ideas that have made the task of using wind converters capable of large power generation provide additional kite utilization to substantially increase the essential buoyancy of the overall system, but the commissioning of a kite is always considered to be an automatic, easy-to-practice activation with self-regulating flight readiness and, therefore, R does not offer any portable solutions which allow the use of a draw kite to be implemented realistically at greater heights. The optimum control of a draw kite, especially in the case of flat wind or occurring wind turbulence, endangers the use of the overall system. It should be noted that first the airship is started and brought into position and only then a draw kite is to be initiated, and in this case this difficult passage should be effected exclusively with a smart controller, in the knowledge that tension kite designs have rather an unstable sail area.

In the underlying idea, therefore, a tandem solution-preferred initiation apparatus (z. B Kitte or Drone or Kite) and Air Screen-Favored; after the initiation of, for example, Kite is pulled into the height of the air screen until the clamping device integrated in the flight screen has fully tensioned the flight screen and thus ensures the sail capability of the air screen. In this case, it is important that the tension screen remains in the controlled vicinity of the airship in a direction-oriented manner, in order thus to make the regulation extension process and the take-up process of the traction screen controllable and controllable at any time. In the case of the underlying idea, in the case of absolute control and alignment of the overall installation, the entire equipment should first bring the entire equipment into the corresponding, optimum suspension position, then the flight screen is to be brought into position and if the lift force has thus been maximized in a synergistic manner, the preferably adjustable rotor blades are to be ideally brought into the wind (=LUV) in order to start and maximize the desired power generation. It is indispensable that the safety of start-up and continuous operation of the overall system is guaranteed. In a worst case scenario, the maximum damage should be limited exclusively to the equipment of the plant; If a crash of the overall system should occur, in the case of such an emergency scenario any assembly is protected from the ground, with the aid of the navigation and software-supporting components and brake parachutes implemented on the building side, which are in each case located on the corresponding assembly; As a result of these safety concepts, the individual assemblies are controlled in a controlled and slow manner into a region which is harmless by the software- and sensor-assisted control; the remaining and critical assemblies are secured by means of the securing structure established in the base station and pulled in at risk.

In principle, it can be stated that the construction of a floating wind power plant (=WKA) is largely identical, namely there are suspended WKAs from a ground station and a floating missile connected to the ground station, which tears open at least one rotor and a gear connected to the rudder. In order to be able to dispense with a cost-intensive tower in a wind turbine, it is known to connect a ground station to a wire cable to which a rotor for generating electric current is attached.

### STATE OF THE ART

an example of wind turbines with a gas-filled airship (here one The PCT Application “PCT/EP2012/000021” should be used in the PCT Application “PCT/EP2012/000021 Magnet-mounted Vertical-Axis Wind Turbine for Large Heights”, and in this concept, due to the relatively low lift force, which results exclusively from the buoyancy force of the gas fed into the ascending balloon in relation to the selected volume of the riser balloon and, in accordance with the own weight of the heavy wind converter-generator unit, the proportions are reproduced realistically and thus the structurally limited size of the wind converter is also predetermined; Moreover, it can be noted that the larger the airship in relation to the wind converter, the more operating-prone and uncontrollable is the overall construction in the case of strong wind.

The unconsidered and statistically relevant fall problem of suspended WKAs is also apparent, since the start-up of suspended WKAs basically involves potential risks of an uncontrolled and thus serious emergency situation; if these, for whatever reason, fall (design error, material fatigue, climatic extreme situation, foreign prescription).

Furthermore, our search revealed that relevant inventions or Constructions Third of the above-described problems have only taken into account rudimentary calculation and, if at all, only at HKWs with low energy recovery <0.5 Mega-Watt.

Any solution tests with the aid of integrated parachute designs with total weights >5 t would be absolutely unrealistic, and therefore such HWKs would not receive an operational approval via living regions; the higher the flight position of a HWKs, the greater the fall radius and corresponding fall risks, i.e. in the case that the tether tears at a point in the upper third, the HWK would be massively driven off by the wind.

In order to solve the problems indicated above, the underlying invention is designed in such a way that the individual assemblies and their primarily intended and integrated security architecture are decoupled in an emergency situation (e.g. fall risk “smart”) in order to reduce the fall risk present in such challenging, 4-dimensional acting constructions to zero percent [0%] bringing them apart from one another in order to obtain the respective fall weight per assembly as low as possible, so that the likewise integrated crash safety precaution per assembly can achieve a maximum effect in order thus to make a latently existing accident risk, in particular for leb and life, at the full end. On the basis of a fictitious fall scenario, the underlying invention was designed in such a way that, in contrast to the prior art, a latently existing fall risk with an integrated safety architecture and safety precautions have to rule out a residual risk for leb and life; in particular, in such a case or event, situation-related and directly opposite and completely self-sufficient measures are initiated, starting from the described safety construction located on the ground station, as well as the sensor- and computer-supported, algorithm-based, “smart” control and control unit and safety systems which are installed on the respective individual components (=assemblies).

The base plate may comprise a turntable mounted for rotation relative to the base plate. A system safety chamber is located on the turntable, in which a safety cell is integrated, which is equipped with a spring-damper device.

The ground station may further comprise at least one controllable airbag device, wherein the airbag device is preferably arranged in the region of an upper end of the safety cell.

The installation safety chamber can furthermore comprise a large cable drum which is driven by at least one quick-action motor, which is preferably located on the right and/or left side of the large cable drum, wherein the at least one quick-action motor is designed to wind the holding cable onto the large cable drum at a high rotational speed. Of course, the fast-running motor can also be used for unwinding the holding rope and particularly preferably has a freewheel and a brake with a spring-damper unit.

The tether may comprise an integrated electrical conductor via which, for example, the electrical energy generated via the generator can be conducted to the ground station and can be conducted there to the energy infrastructure. Likewise, a signal and data exchange between the electrical units of the ground station and the wind converter and/or of the airship can take place via the integrated electrical conductor. The electrical conductor can be multi-core and provided with different line cross-sections.

The installation safety chamber can be mounted so as to be pivotable with respect to the rotary disk, for this purpose the installation safety chamber is preferably suspended at its lower end in a movable rocking structure and is particularly preferably additionally attached to a pivoting device of the installation safety chamber in a movable manner via a holding carrier of the rotary disk in order to support the alignment capability.

In addition, pivotable telescopic arms can be arranged on the rotary disc, which telescopic arms are preferably positioned 180 degrees to one another and to the left and to the right of the installation safety chamber, to which a position holding cable is connected via in each case one high-power cable drum, which is fastened directly to an outer structure of the rotor.

The high-power cable drums are not responsible for the vertical movement of the wind converter, but are designed to provide an additional braking function for the wind converter in a fall scenario. The base plate can be designed to be movable, by means of vertically movable individual wheel suspensions installed on the base plate and controllable wheels fastened to the individual wheel suspension.

A plurality of, preferably four anchoring piles, which are designed for anchoring the base plate in the ground, can be arranged on the base plate, wherein the anchoring piles are preferably each provided with a thread and a drill head.

The wind converter may comprise a vertical (e.g. Savonius/Daerus rotor) or a horizontal rotor formed as a wind wheel suspended from a structure of the wind converter, wherein the structure of the wind converter is preferably constructed of an outer and inner construction and in the center of which the rotor is cardanically suspended between the outer and inner structures.

At the lower end of the inner construction, the tether can be connected to the wind converter in a load-bearing manner via compressed-air-filled explosive capsules or an electromagnetic clutch, wherein preferably an anchor weight and/or a brake parachute is arranged at the lower end of the inner structure.

It is possible to provide a fastening of the supporting flight kite(s), flight screen (“spinning field”) not on the airship/balloon unit, but directly on the outer ring of the converter unit in order to relieve the airship in the case of heavy wind.

A reduced balloon unit can be provided which merely comprises the tether(s) (zw. ground station and airship/balloon) and the assembly “airship/balloon” is intended to convey upward.

A Kl-based or software-controlled lift device can be provided, which can draw the converter unit from the ground station up to the optimized energy recovery height position. This process can only be carried out if the tensile force due to the activation of the air bag (“spunbond”) and/or kite and/or kite increases so much that the additional weight of the converter unit to be pulled up and its start-up, i.e. orientation in the LUV direction, is possible.

The wind converter may comprise:

Kl-based or software-controlled braking (braking and/or steering parachute/e, electromagnetic and and/or electro-pneumatic and/or electromagnetic blasting/separating units) and separation unit to separate the entire assembly in an emergency, the entire assembly can be disconnected from the overall system and controlled, controlled and safely fall to the ground station.

For the sake of safety, Kl-based or software-controlled outer hook devices should also be installed on the outer ring of the assembly, which devices can be activated ultra-fast in case of an emergency by means of a cable-based or radio-controlled triggering unit.

Installation of a collecting net directly or indirectly on the ground (with or without a central hole; consisting of 4×floor pillars, which are each equipped with a spring/damper unit at the end of the pillar), which in the event of an emergency can brake the falling assembly in a controlled manner and can absorb without damage.

Telescopic arms can preferably be arranged between the outer structure and the inner structure. Preferably, compressed-air-filled explosive capsules or the electromagnetic clutch and/or in each case one brake parachute can be arranged at the lower end of the inner structure, on an outer side.

The airship can comprise a gas-filled balloon, preferably a riser balloon, on which a flight screen is directly located, which in flight mode is dense on the balloon.

The airship and/or the balloon unit can preferably have the following features:
gas outlet devices or discharge valves in the outer balloon skin in order to ensure a controlled, Kl-based or software-controlled lowering of the balloon, and/or gas discharge cut-outs within the balloon outer skin in order to ensure a faster, abrupt gas outlet, Kl-based or software-controlled decoupling separation maneuver in an emergency situation in order to be able to separate the assembly from the overall system quickly, Kl-supported or software-controlled brake parachute and/or steering parachute in order to control the airship in a controlled and secured manner to the ground (in order to ensure reusability).

The flight umbrella can be pulled up by a self-flying, small flight initiation apparatus, for example by a kite, a drone or a kite, and in the starting phase, the orientation of the flight screen can be controlled by smart rope winches which are arranged on the gas-filled balloon and wherein the flight screen is connected to the cable winches via cables, and wherein the flight-initiating apparatus is connected to the flight screen via a cable.

An exo-skeleton can be arranged within the flight screen in such a way that the flight screen is unfolded and stretched after the starting phase and by an integrated control unit.

The flight initiation apparatus can comprise a brake parachute, which is preferably triggered prior to the separation of the flight initiation apparatus, with the aid of a separating device arranged on the cable, wherein the brake parachute is arranged at an upper dead center of the flight screen.

A compressed-air-filled explosive capsule or an electromagnetic clutch can be arranged as a separating device at the top dead center of the flight screen.

In the interior of the airship, it is preferably possible to install durable safety hoses which in turn comprise a plurality of gas chambers and which each have inlet and outlet valves and pressure sensors which are supplied by the on-board gas supply network which runs between the safety hoses and which are protected and delimited with respect to the surroundings, by the robust outer skin of the airship, which is preferably structured in a shark skin-like manner.

A holding box can be mounted on the airship in the wind shadow, with an integrated safety cell, in which there is preferably a liquid gas tank with an inclusive gasification unit and a gas line, which is connected directly to the gas supply network, so that the gas supply of the safety hoses and/or its individual gas chambers can thereby take place.

Alternatively, an electrolyzer for generating hydrogen, a water tank, a water pump and a gas pressure distributor unit for the generated hydrogen can be arranged in the safety cell.

As a further alternative, an integrated accumulator, preferably a lithium-ion battery, can be arranged in the safety cell.

The safety cell can be fastened to the holding box by at least one safety belt and at least one closure and can additionally comprise at least one compressed-air-filled explosive capsule and/or an electromagnetic clutch and a brake parachute in addition to the at least one closure.

All surface materials (outer skin), which are provided for the subject matter of the invention and the flying embodiments thereof, should preferably be provided with a wind-current-optimizing, current-line-promoting microstructure skin, similar to a shark skin, and simultaneous preventive protection against any soiling (lotus effect), through the atmosphere or possibly animals.

All airships (gas-filled round balloon or belliferous balloons as well as zepeleins) or the described embodiments thereof are filled with different gases (e.g. helium and/or hydrogen).

Each wind converter embodiment is basically connected to a generator for power generation and preferably also to a transmission connected in between, in order to be able to regulate (increase or decelerate) the speed which occurs on the generator axis. In addition, all rotor blade embodiments should preferably be movable and connected to a “smart” control unit, so that as a result, the angle of incidence (Luv or Lee) of the wind on the rotor blade can be controlled.

All gas balloons preferably have, by way of electrical, 360° pivotable, software- and sensor-assisted, autonomous or automatic and or remote-controlled (emergency situation) X-turbo propellers and electrical, software and sensor-based, autonomous or automatic and or remote-controlled (emergency situation) adjustable elevator and/or rudder for stabilizing and positioning purposes.

In addition, all turbo propellers should preferably be adjustable to the right or to the left and preferably run in opposite directions to the rotation of the wind turbines.

In an acute emergency (crash scenario), the separation of the individual assemblies or parts from the GK should preferably take place according to a smart, integrated step plan (“evacuation”) and the smart control system is designed in such a way that the decision as to whether and which assembly, as is to be activated by the GK and which brake systems are to be activated at what time, should take place in a smart and completely independent manner; the most stringent scenario for Leb and life as well as the material used.

Preferably, the kite and/or kite missiles should be made of a very durable and loadable sail material or similar material, in particular also the surfaces which are present within the gaps in the vertical wind converter designs (for example Dararius or Sonius wind converter) and these sail surfaces should be located in the inner region of the frame and/or should be gathered in the region of the wind-harvesting zone (=harvesting) only in the region of the wind-harvesting zone (=harvesting) and should only be driven by the power supply from the ground station or indirectly by the current generated on board are pulled out and firmly fixed with the aid of the cables respectively tensioned between the frames.

The underlying invention and its described embodiments are preferably equipped with a computer-aided ground control system, navigation (GPS) and/or inertial navigation system for position determination, radar, infrared, sonar systems, radio frequency, turbo fans (sideprops), or computer-supporting software, which uses a prediction analysis and worst-case scenario-optimizing algorithm and digital matrix control logic, collision protection and warning systems for the overall system and its operation. In addition, audio-visual warning systems on the deciding components or assemblies should be implemented as simple, preventive protective measures.

The outer skin of the gas-filled balloons and or kite/kite designs should preferably consist of flexible, robust solar modules if they should have the same material requirement which are characterized by high-performance materials.

Preferably, all embodiments or assemblies should also be equipped with an effective lightning protection, de-icing and defrosting devices (e.g. sheathed heating wires) and substantially protective airbag designs, with preferably integrated, “smart” air discharge valves, which are intended to develop a damping effect, by controllable, slowly escaping air outlet, up to a maximum amount of air, in the case of multiple bottom contact.

The “sailcloth material” could also consist of flexible solar modules if they die like high performance sailing materials.

An additional single or double tail unit can be attached to the gas-filled ascending balloon in each case at the lateral center of the airship, which is preferably also fitted with additionally gas-filled chambers on the longitudinal side and below the tail unit and in each case at the end by two rudder and one Elevator or with a horizontal propeller unit.

In the wind shadow of the gas-filled ascending balloon, an additional folded draw kite can be arranged, which is fastened to an upwardly movable pull kite carrier and which is pulled upwards by means of a smart cable winch, a traction cable pull kite and an additional deflection roller.

The traction kite can be arranged with the movable pull kite carrier on the tail unit, preferably in the middle thereof.

On the airship, a folded draw kite can be arranged on a movable trigger visor (slide).

The movable trigger visor can move centrally in a central rail, which fixes the maximum freedom of movement by position stoppers.

The draw kite can be fastened to the upper side of the kite, the function of which is a type of climbing aid for the traction kite.

In order to counteract excessive drift of the converter unit and/or of the airship or balloon in the case of high wind, lateral propeller units or “sideprops” can be installed for stabilizing and fixing/fixing the overall unit.

In the following, embodiments of the underlying invention are explained in more detail with reference to the attached drawings, in which:

FIG. 1 shows an embodiment of the wind turbine according to the invention, primarily its safety and safety architecture, as an overall construct in a longitudinal section.

FIG. 2 shows a schematic view of the ground station together with Safety chamber

FIG. 3 shows a cross section of the carriage device

FIG. 4 shows by way of example the base plate with pivotable telescopic arms

FIG. 5 shows a cross-section of the schematic view of a vertically oriented wind converter example in an oblique, wind-induced oblique orientation of the outer structure

FIG. 6a to c show schematic views of a wind converter example of a vertically suspended Dareus rotor or horizontally suspended rotor blade converter with cardanic suspension

FIG. 7 shows a further wind converter example—here a horizontally suspended, rotors-driven wind wheel—with rotors which are oversized in relation to the outer structure

FIG. 8 shows a horizontally oriented, rotationally driven wind converter example, in an inclined position of the overall system caused by the wind force

FIG. 9 shows a further embodiment of a vertically suspended Dareus wind wheel in a rectangular constructed outer structure

FIG. 10a shows a schematic view of a horizontally suspended, rotors-driven wind wheel with a connected tail unit with elevator and rudder

FIG. 10b shows a horizontally driven propeller unit instead of a vertical rudder

FIG. 11 also shows a horizontally suspended twin-rotor wind wheel

FIG. 12 schematically shows a horizontally suspended rotor-driven wind wheel, with fixed position cables on its outer structure with the aid of distance-securing telescopic arms located on the ground station

FIG. 13 shows, by way of example, a Dareus wind converter unit with “smart” controllable side rudders

FIG. 14 schematically shows an initiation kite unit

FIG. 15 shows a cross section of a riser balloon with a tandem flying unit consisting of an initiation kite unit and a non-tensioned flight screen

FIG. 16 shows, as an alternative for an initiation unit, a drone with laterally positioned four fan units (=Sideprobs)

FIG. 17 shows a schematic view in the first step of an air shield closely adjacent to the ascending balloon without any of the above-described flight initiation units (kite or kite or drone)

In a second step, FIG. 18 shows a flight screen which is inactive from the ascending balloon and is not tensioned by an exoskeleton

FIG. 19 shows, in a final step, a fully stretched, flying air screen

FIG. 20 shows the schematic view of a traction kite initiation embodiment with a luggage carrier positioned directly on the gas-filled rising balloon or on a possibly integrated guide mechanism

FIG. 21 shows, as an alternative, a luggage carrier on a realized double tail unit with the same tensile kite initiation configuration

FIG. 22 shows, in the bird's eye view, the luggage carrier on a single tail unit

FIG. 23 shows a kite rack construction on a movable and alignable trigger visor

### ALTERNATIVE DRAWINGS

FIG. 20A shows the schematic view of a traction kite initiation embodiment with a luggage carrier positioned directly on the platform, or on a possibly integrated guide mechanism provided with an air bag

FIG. 21A shows a riser embodiment with alternatively positioned height and rudder

FIG. 22A shows, in the bird's eye perspective as an alternative, a luggage carrier on a realized double tail unit with the same tensile kite initiation configuration

FIG. 23A also shows, in the bird's eye view, the luggage carrier on a single tail unit

FIG. 24 shows, by way of example, the movable kite carrier construction in the action phase

FIG. 25 shows a cross section of an installed tail unit, which additionally has a gas chamber positioned below and between the riser balloon and the tail unit.

FIG. 26 schematically shows the central guide rail of the movable trigger visor.

FIG. 27 shows, in cross section, the safety hose chambers of the flight unit

FIG. 28 shows the safety tube chambers in the bird's eye view without the protective riser balloon outer skin.

FIG. 29 schematically shows a safety capsule 77 attached to the gas-filled airship with an integrated liquid gas tank and various auxiliary devices which are intended to fill the gas cells in the airship with gas when there is a pressure drop

FIG. 30 shows as an alternative self-sufficient gas filling with the aid of an electrolyzer which produces hydrogen in the safety capsule 77 and thus supplies the gas chambers with hydrogen when there is a pressure drop there

FIG. 31 shows a further variant of the gas supply, with the aid of a liquid gas tank, which, however, is connected to the ground station and which introduces the liquid gas with a gas pressure line directly to the airship and beforehand into the gasification device, in order thus to be able to fill gas chambers with gas at all.

FIG. 31 shows an alternative to equipping the safety capsule 77 with

FIG. 1 shows a total construct

FIG. 1 shows, in cross section, an exemplary embodiment, in particular the comprehensive safety and safety architecture, of the underlying invention as a total construct (=GK). It should be emphasized here that not all detail solutions have been taken into account in the illustration. The GK consists, starting from the assembly base plate 10, which consists of an inner-half, ball-mounted rotary disk 11 and an outer, stationary part, which have a plurality of, preferably four, anchoring piles 14, which have a software-supported motor and control unit as well as existing threads and drill head, which are self-milling at button pressure into the ground. Furthermore, steerable wheels 12 are located at the outer corners of the base plate, each of which has a height-adjustable, software- and sensor-supported, motor-driven individual wheel suspensions 13 and act in a reciprocal manner with respect to the anchoring piles. In order to take account of a deflection of the GKs to be expected by the wind force, a type of rocking construction 16 is located on the rotary disk in which the pivotable installation safety chamber/maintenance box 17 corresponds to the angle of inclination of the GK

It is possible to align its purpose without problems, among other things the controlled suspension (elevator principle) of the wind converter (=WK) and/or airship (=LE; In order to be able to carry out any maintenance work (=normal operation) efficiently and, in particular, in order to be able to carry out any maintenance work (=normal operation) efficiently and, in particular, in an emergency situation (risk of fall), the GK or the assembly wind converter is integrated ultra-quickly into the safety cell 22 integrated as a frog of the plant safety chamber 17 with an integrated, extremely loadable airbag structure 22a, which is located at the upper end of the safety cell 22 and which can be changed at its angle of inclination with the aid of a sensor- and software-supported control unit in order to determine the impact velocity of the wind converter unit, which is to be taken up more quickly than the braking systems (z. B Autorotation of the Wind Wheel, Brake Parachute, and Flight Screen, etc. Results Significantly Braked Drop Speed, so that the wind converter unit is forced by the system, such as a solder, to be controlled perpendicularly to the safety cell 22 or drastically dropped by the acting and activated brake systems to prevent destruction of the wind converter unit, for this purpose the tether 24, which is preferably made of an inner jacket (=integrated electrical conductor cable); Alternatively: holding rope and in each case parallel, separate conductor cable 45b and/or separate gas line 83) and an outer casing, the function of which, in addition to the actual holding function of the GKS, is to conduct the current flow from the generator 31 flanged to the wind converter with preferably additionally integrated transmission to the ground station. Furthermore, a plurality, preferably 2, pivot arms 25, which can be pivoted and controlled on the rotary disk 11, which additionally secure the WK with spacing safety cables 25, in particular are intended to counteract any drift of the WKs in the case of strong wind. As the next assembly, the WK can be seen, which in turn consists of an outer construction 27 (round or elliptical circle or rectangle) as well as an inner construction 28 (round or elliptical circle or rectangle) and a WK suspended in the interior of the inner structure (here a Dart rotor 30a; alternatively, a Savonius rotor and/or hybrid constructions would also be conceivable) at the upper and lower end of which a generator and preferably upstream transmission unit 31 is positioned, which is connected by means of a cardanic (pivotable or pendulum-capable) suspension, for further alignment assistance, a controllable rudder 44 should preferably still be located on the left and right sides of the WKs and/or via an entire laterally mounted tail unit 42 with an, for example, Further, the vertical position of the WKs is intended to have, with the aid of, sensor- and computer-assisted, electro-pneumatic or hydraulic telescopic arms 34 positioned at the lower region between the outer and inner construction, as well as preferably an additional, aerodynamically shaped anchor weight 32 attached to the lower end of the inner structure. The next assembly airship (=LU) consists inter alia from a gas-filled (helium and/or hydrogen) riser balloon or zeplin 46 with an exemplary guide mechanism 42 with respective heights-43 and rudder 44 located at the rear, which also is intended to contribute to the fact that the GK overall always rotates into the wind (=LUV) and remains there completely during the energy generation; Furthermore, the flight screen 49 mounted here with an integrated exo-skeleton 49, which is fastened by the sensor- and computer-assisted cable winches 47, which are located on the airship and which are supplied by the secondary circuit of the generator and which correspond to corresponding holding cables 48 and which, with the aid of the flight-initiation apparatus (here a kite 54) located at the end of the GK, is pulled into position in such a way that it immediately after the flight-initiation apparatus (here a kite 54) supported by the sensor- and computer-aided electrically operated cable winches, at any time controlled decoupling from the gas-filled rising balloon 46 and subsequent activation of the exo-skeleton mechanism (analogous to a mechanical skeleton of a sun screen or umbrella) for the tension of the flight screen 49 and the thus produced and intended sail function, in order thus to increase the buoyancy forces of the gas-filled riser balloon/zeplin 46 in a synergistic manner.

The holding cables can comprise a Kl-based or software-controlled braking unit (for example, drop pockets installed on the holding ropes/s, which open during the sudden drop-down and as a type of small parachute significantly increase the frictional resistance of the holding cable), so that, in the case of an emergency (break-off of the holding rope/s), the holding rope(s) can be wound in a controlled and damaged manner with the aid of the quick-action cable drum fastened to the base station.

One of the decisive advantages of the inventive concept over the prior art is that an emergency situation (fall scenario) causes, for example, The safety and safety architecture is designed in such a way that, in combination from the integrated smart cards (=sensor- and software-supported, algorithm-based control units) “control devices and safety equipment (e.g. flight screen) and early warning systems (audio-visually triggered, clearly perceptible alarm signals), the GK and/or individual assemblies are maximally secured to the ground or sink, in order thus to exclude a latently existing risk for leb and life per-active and preventive and to significantly minimize any material damage to the GK and/or its individual part.

FIG. 2 shows the assembly base plate 10, which consists of a ball-mounted rotary disk 11 located inside and an outer stationary part. Furthermore, there are a plurality of anchoring piles 14, preferably 4, which have a “smart” motor and control unit as well as existing threads and drill head 15, which are self-milling at button pressure into the ground in order thus to guarantee the necessary anchoring of the GK. Furthermore, steerable wheels 12 are located at the outer corners of the base plate, each of which has a height-adjustable, software- and sensor-supported, motor-driven individual wheel suspensions 13 and which correspond to the reciprocal of the anchoring piles. In order to take into account a deflection of the GKs to be expected by the wind force, there is a type of rocking construction 16 on the rotary disc, in which the pivotable safety chamber 17 can move, which is fastened to a plurality of, at least two, robust holding supports 18 and a pivoting device 19; In the interior of the safety chamber 17, a large-cable drum with sensor- and computer-supported fast-running take-up motors 21 located on the left and right sides in each case is centrally suspended and a safety cell 22 located above, which has a spring-damping unit 23 inside it, the purpose of which includes, inter alia, the controlled, not critical and efficiently and efficiently braked by the integrated spring damping unit 23 (driving chair principle) of the wind converter (=WK) and/or airship (=LE; Gas Filled Riser or Zeplin [Kiel/Impingement Airship]) to be able to perform any maintenance work and, in particular, to repeat the GK ultra-fast in a safety cell 22 designed such that the assembly WK and/or the airship assembly can ideally be serviced by the mons in an emergency situation (fall-off risk); For this purpose, the holding cable 24, which preferably consists of an inner casing (=electrical conductor cable) and an outer casing, the primary function of which, in addition to the actual holding and retrieval function of the GKS, is to conduct the current flow from the generator 31 to the ground station 10; above the safety chamber 17 there is still a stable and durable airbag unit which has 22a with integrated, a plurality of smart air discharge valves (damping function), which optimally brakes the cost-intensive WK in a gentle manner. Furthermore, a plurality of, preferably 2, pivotable and motor-controlled pivot arms 180 degrees are secured together with support provision 25, which additionally secure the WK with the spacing safety cables 25, in particular in order to be able to counteract any drift of the WKs in the case of heavy wind and, as a result of the preferably installation on the rotary disk 11, a twisting of the tensioned cables is prevented. The distance safety cables are also wound with a quick-action cable drum and before the assembly of wind converters can be secured in the safety cell, the 180-degree telescopic pivot arms are positioned in length such that the tip remains positioned significantly higher in order to brake the wind converter in an emergency situation (e.g. fall scenario) via its tether connection in a controlled manner via the smart control unit (=negative case acceleration) before the wind converter impacts the airbag system 22a located on the safety cell 22 in order to thus progressively prevent significant fall damage.

FIG. 3 schematically shows the rocking construction from the side view, in which the safety chamber 17 can pivot back and forth, depending on the wind strength and correlating deflection of the GK.

FIG. 4a again shows the module base plate 10 with the additionally, sensor- and computer-assisted, electrodynamic and/or electro-pneumatically controlled, preferably 180 degrees, pivoting arms 25, which are additionally supported on the rotary disk 11 and are additionally held in position by telescopic supports 90, and the cable deflection rollers 60 positioned at the upper end and the high-power cable drums/cable winches 91, which are located on the ground and are driven by a smart and electrically operated control unit, with the respective position holding cables 26; by means of these high-power cable drums/cable winches, in an emergency situation (fall risk), the brake units with different brake units. For example:

Overall system equipped with brake parachutes, or in particular the assembly of wind converters, can be pulled down more quickly to the floor group or to the safety cell, such as a solder, than would fall downward by the force of gravity, in order thus to rule out a risk for leb and live, and by braking the assembly wind converter, with the aid of the safety cell 27 integrated in the installation safety chamber 17, at the angle-controllable airbag unit/s 22a located at the upper end, as well as the within the installed spring damping unit 23 plus in cooperation with the pivotable telescopic arms 25, which in a fall scenario are to be at an angle to such an extent that they are still to be able to brake the assembly of the wind converter in a controlled manner by the tensioned position holding cables 26, so that in the sum of the described and installed braking systems the fall damage for the overall system or for the assembly wind converter can be minimized.

In the case of a horizontal wind converter 38, the rotor unit thereof should preferably be activated as an additional braking system and for additionally increasing the desired overall braking force (negative acceleration) in such a way that in this case the braking effect is additionally generated by the autorotation of the rotor and in this way an emergency situation (=fall scenario) should be carried out automatically with the aid of the smart control unit, and in this case the order to be carried out of the activities to be carried out should be carried out as follows:
1. the anchor weight 32, if installed, must be separated from the inner structure 28 using the compressed air-filled explosive capsules and/or electromagnetic clutch 78,
2. The telescopic arms 34 for fixing the inner structure in order to ideally bring the rotor unit into the wind (=LUV) are then to be separated from the fastening point of the inner structure by the attached, compressed-air-filled explosive capsules and/or electromagnetic coupling 78, so that the inner structure is freely movable,
3. in parallel, the controllable or movable rotor blades are rotated out of the wind,
4. The brake parachute 82 installed at the bottom dead center of the inner structure 28 is first activated and when the rotor unit with the inner structure 28 is to be in the desired horizontal position
5. the brake parachute, which is also mounted on the inner side of the inner construction but at the top dead center, is activated by the smart control unit in order to thereby keep the rotor unit in the optimum, horizontal position, so that the autorotation is triggered and the maximum braking effect thereof and the two brake parachutes 82 located on the sides in each case achieve a synergistic braking effect.

FIG. 4b shows, in addition to FIG. 4a, a mobile embodiment provided with vertically adjustable individual wheel suspension 13 and steerable wheels 13, in which the base plate 10 with the integrated rotary disk 11 is anchored in a type of lifting platform, which is preferably anchored by 4 supporting pillars and by means of which the base plate together with the installed installation safety/maintenance chamber and the preferably electropneumatic and/or hydraulic up to the ground can be lowered by means of the running channel 94 located in the support pillars and the countersunk head nose 93 anchored in the floor plate, and as a result the accessibility of the maintenance-intensive assembly wind converter and also the assembly of airship, which are connected to one another on the base plate by means of the retaining cable 24 can be pulled down as required.

FIG. 5 shows the schematic view of the BG wind converter consisting of an outer construction 27 (round or elliptical circle or rectangle) and an inner construction 28 (round or elliptical circle or rectangle) and a vertical WK suspended in the interior of the inner structure (here a Dareus rotor 30a; It could equally well be a Savonius rotor and type-related rotors) at the upper and lower ends of which a generator and preferably upstream gear unit 31 is positioned, which by means of a gimbal 33 which always provides 90 degrees perpendicular to the wind direction by the WK; Furthermore, the vertical position of the WKs is to be determined with the aid of, in each case, sensor- and computer-assisted, electro-pneumatic or hydraulic telescopic arms 34 positioned at the lower region between the outer and inner construction, and preferably also an additional, aerodynamically shaped, attached to the lower end of the inner structure, which anchor weight 32, in an emergency situation, has the aid of the explosive capsules or electromagnetic couplings 78, which are preferably filled via compressed air, and preferably a brake parachute 82, in order thus to be safely separated from the GK and/or assembly from the wind converter and slide to the ground.

FIG. 6a also shows the BG wind converters and, in addition to FIG. 5, in addition to FIG. 5, a controllable rudder 44 as well as the position holding cables 26 already described are preferably still able to be released ultra-fast in an emergency situation on the left and right sides of the WKs in each case on the left and right sides of the WKs. Preferably, a tensioning device 95 (individual thin tension cables), which extend from one rotor blade to the other rotor blade, is to be tensioned in the center of the vertical wind converter (Dareus rotor 30a), and in one of the rotor blades the rice-resistant, durable sailing material should preferably be located in such a way that a large braking resistance is produced by the opposite rotor blade, by means of which the traction system is located, so that a large braking resistance is thereby produced, in order thus to produce the BG in an emergency situation (Fall scenario) in addition to being able to decelerate; In addition and preferably, at the upper and lower ends of the inner structure 28, preferably in each case on the outer side, compressed-air-filled explosive capsules or electromagnetic clutch 78 and in each case one brake parachute should be located so that, in an emergency situation (fall scenario) by individual, situation-dependent abortion of the assembly wind converter, the latter can be brought into the horizontal in order to support the dart rotor 30a, by the time-offset pulling of the brake parachute 82 positioned at the bottom and at the top, and in particular to hold it so that the preferably integrated sail material, which is located between the two rotors, can bring about its optimum, additional braking effect.

FIG. 6b shows, in comparison to FIG. 6a, a horizontal rotor blade converter 30b and for illustrating an exemplary embodiment of the mounting of an electrical conductor 45b starting from the generator unit 31.

In addition to FIGS. 6a and 6b, FIG. 6c shows the positioning of compressed air-filled explosive capsules or electromagnetic couplings 78 together with inclusive brake parachute 82; by means of the blasting capsules, the fixed telescopic arms 34 are to be separated from the inner structure 28.

FIG. 6d illustrates the end position of the BG wind converter or the wind wheel (here a rotor blade converter 30b) in an emergency situation (fall scenario) with the aid of the included, two smart controllable (important: Time offset) Brake parachute 82, which is intended to bring and hold the inner structure 28 together with the wind converter into the horizontal plane, in order to bring the rotor of the wind converter into “autorotation”, so that the falling speed of the BG wind converters is maximized in interaction with the brake parachute and a low-risk assurance of the BG wind converter together with additional equipment can be guaranteed.

FIG. 7 schematically also shows the BG wind converters, but with a horizontal WK with an oversized, for example fixed rotor blades 39 or by electro-pneumatically and/or electro-dynamically changeable, telescopic rotor blades in size, length and area, the area and dimension of which is greater than the outer structure 27, so that upon activation, i.e. the rotor blades 39 enter the wind (=LUV), by the rotation of which the outer structure and the rotor blades are damaged and would be destroyed at all at all at the expected high wind strengths. In order to solve this problem, the outer structure 27 should be constructed only half, which has, in addition to the left and right sides, respectively adjacent, stable outer arms 41 which, in turn, stabilize the entire assembly with a stable lower connecting element 37 and corresponding stable holding cables 48 or rods. The outer position cables 26, which are also fastened and extend to the ground station 10, are fastened directly to the outermost end of the side arms.

FIG. 8 also shows a BG wind converter with a horizontal WK, which has a laterally mounted tail unit 42 with a height 44 and rudder 43 located at the rear.

FIG. 9 shows the schematic view of a BG wind converter with a vertical WK (here a Dareus rotor 30a) which is located within a rectangular outer and cardanic suspended 33 inner construction 28; Furthermore, the WK is provided with a preferably pre-stored transmission by a generator 31 attached at the bottom and/or top so that here the generated current can flow directly into a primary circuit via the conductor integrated in the tether 24 directly to the ground station as well as indirectly in a demand-optimized secondary circuit which, inter alia, supplies the cable winches 47 of the tethers 48 in the individual assemblies (ground station, wind converter/wind wheel, airship with linked flight screen) and for operating a flight initiation apparatus (55 or 56 or 57) with current for their drive.

FIG. 10a shows a wind converter with horizontal WK 38 and integrated rotor unit with at least one or more, preferably 3, rotor blades 39 and a tail unit 42 with heights-43 and rudder 42 located at the rear.

FIG. 10b shows a wind converter with horizontal WK 38 and integrated rotor unit with at least one or more, preferably 3, rotor blades 39 and a tail unit 42 with a horizontal propeller unit 45 located at the rear and supplied via the secondary stoma.

FIG. 11 shows a schematic view of a TWIN rotor unit 40, the front side and the rear side of which are equipped with a rotor unit, with one or more, preferably 3 rotor blades, and which are driven mutually by the wind in order to successfully counteract occurring torque forces; in this case, the rotor blades of the front rotor unit are preferably smaller than that of the downstream rotor unit.

In addition to FIG. 5, FIG. 12 also shows a connected tail unit 42 in order to additionally supplement the wind in the wind (=LUV).

FIG. 13 also shows the BG wind converters and, in addition to FIG. 5, a “smart”, controllable rudder 44 is preferably still located on the left and right sides of the WKs for further alignment support in the wind.

FIG. 14 shows, by way of example, an example of a flight-initiation apparatus of the corresponding flight screen 49, namely a kite 54 to be preferred; kites are in principle easy-to-flight aircraft and already fly independently at low wind and are easily controllable and controllable flying objects by a smart controller.

FIG. 15 shows a schematic view of the last assembly airship (=LU) consisting of a gas-filled (helium and/or hydrogen) rising balloon or zepline 46 (keel or impingement airship) of various sensor- and computer-controlled electrically driven cable winches 47 and corresponding retaining cables 46, which, in the deactivated state, is stretched over only with an additional exo-skeleton 50, which, like a second, but area-wise max-half climbing balloon skin, is brought into the wind around the ascending balloon, which then takes over the function of a kite, in order to maximally reinforce the climbing force of the GK.

### DETAILED DESCRIPTION OF THE PREFERRED EMBODIMENTS

Referring now to the figures of the drawing in detail and first, particularly, to FIG. 1 thereof, there is shown a suspended air screen 49, with the exo-skeleton 50 shown here, of the associated control unit 51 located in a cylinder, in the interior of which a spring/damper unit 52 and a plunger 53 as a de- and activation control unit, which is regulated by electro-pneumatic and/or hydraulic, sensor- and computer-aided control, the current source of which is the secondary circuit, and the flight-initiation apparatus (here a kite 54) located at the end of the GK, in such a way that it is controlled at any time by the gas-filled rising balloon 46 and thus the desired activation of the exo-skeleton mechanism and thus the desired tension of the flight screen 49, in order to increase the buoyancy forces of the gas-filled riser balloon/zeplin 46 in a synergistic manner.

Moreover, in an existing emergency situation (fall scenario), the flight screen can function as an additional parachute for the assembly.

FIG. 16 also shows an exemplary embodiment with a flight tandem that, instead of the kite or kite mentioned in FIGS. 14-15, which is necessary for the required initiation and climbing aid of the air screen, by a drone equipped with a plurality of turbo fans (=sideprobs), preferably 4 sideprobs, in order to be able to take over the necessary “birth aid”. For this purpose, the drone is to be fed either with the on-board electrical secondary circuit (preference) and electrical connecting cable or alternatively by carrying out a light small engine which is operated with fossil fuels and a small fuel tank.

After successful work and successful flying screen 49, the kite/kite or drone is preferably intended to separate from the flight screen with the aid of the tether release device (integrated separating disk) located on the flight screen 49 and with the aid of the attached, preferably steerable Brake parachute 82 is able to float independently to the ground or best directly to the ground station and, in the case of the next maintenance work on the GK, are again mounted on the air screen in order to be able to resume its function during the next start of the GK.

FIGS. 17-19 schematically show the advance of an activated air shield 49, in particular the triggering mechanism, the control unit of which is located in a safety cylinder 51 in the interior of the flight screen and within the recess in the central axis of the airship 46 in order to prevent any spark flight and associated risk for the gas-filled airship; in the interior of the cylinder there is an electro-pneumatic or electro-hydraulically driven tensioning device which, with the aid of the secondary current circuit of the generator and or emergency current operation (if installed), is maintained, which is maintained by an entrained accumulator which consists of an activatable punch 53 and a spring/damper element 52 for counter-regulation and a smart control unit for guiding the tensioning/expansion process of the integrated exo-skeleton 50 and the associated flight capability of the air screen.

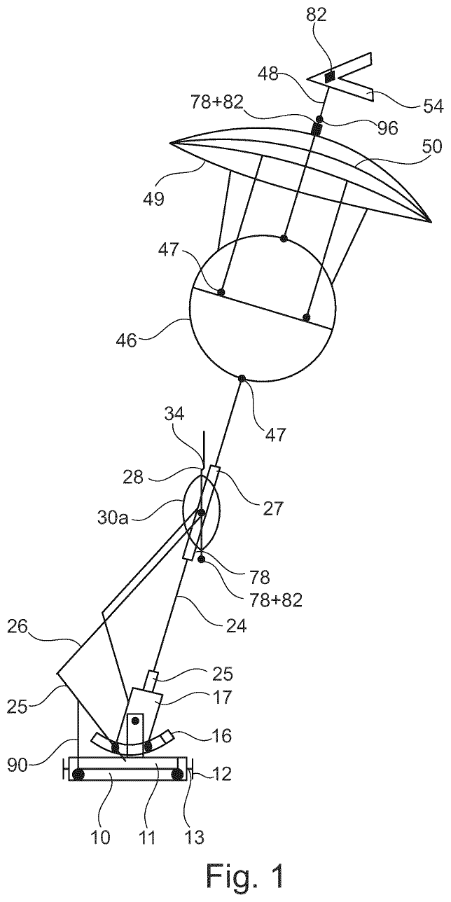

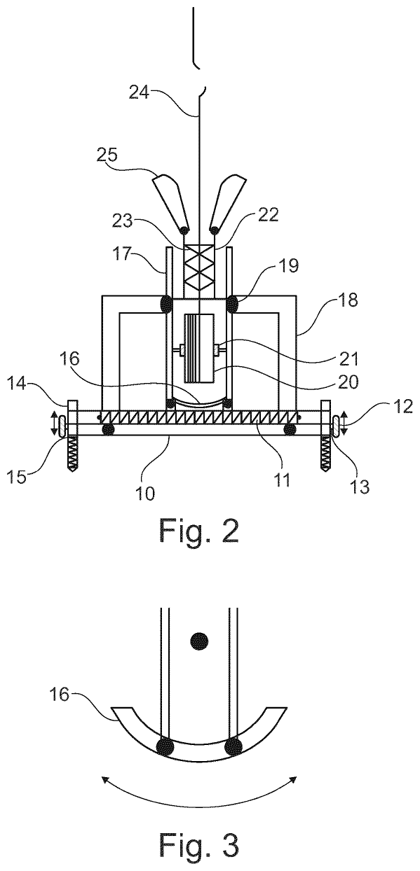

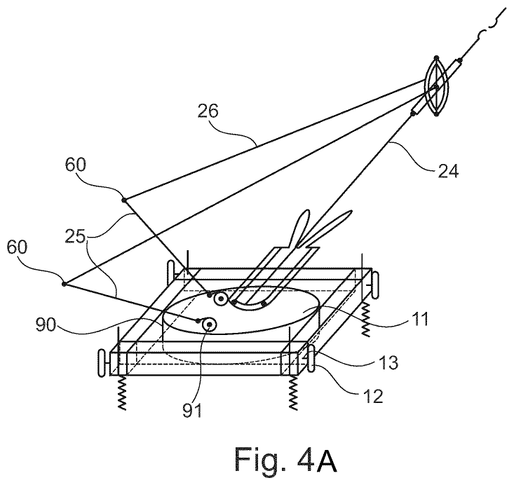

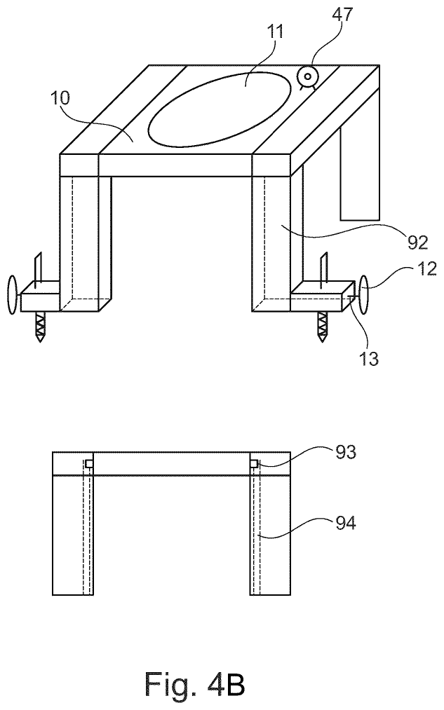

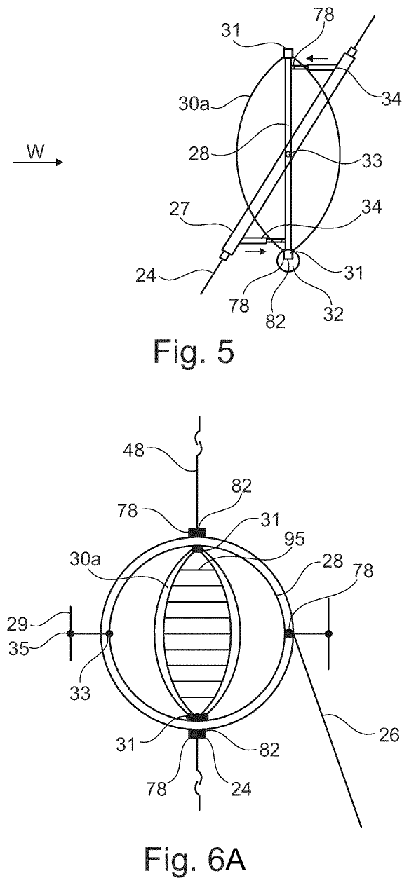

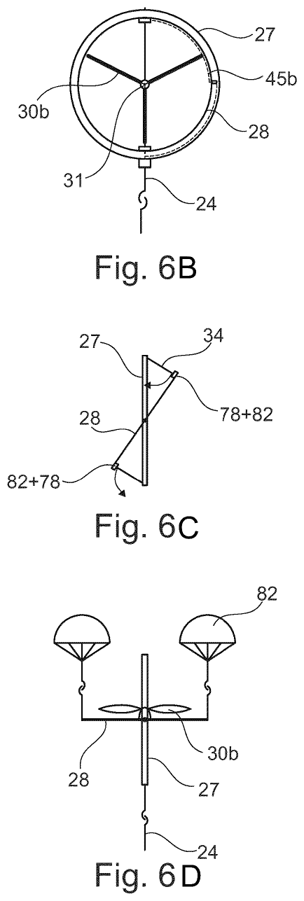

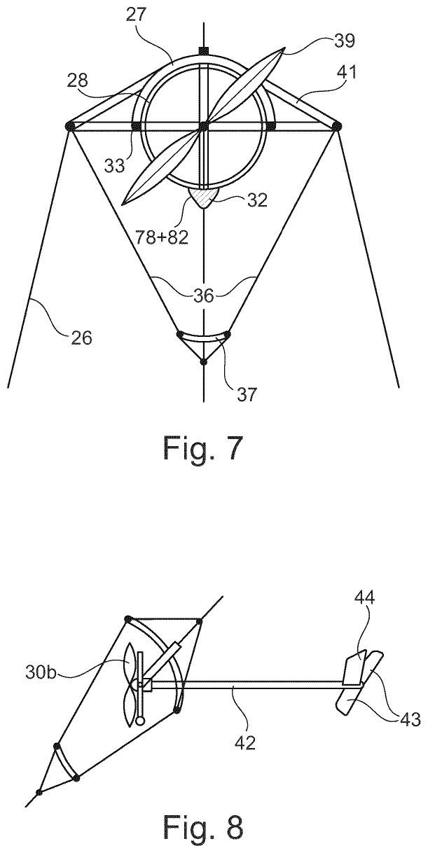

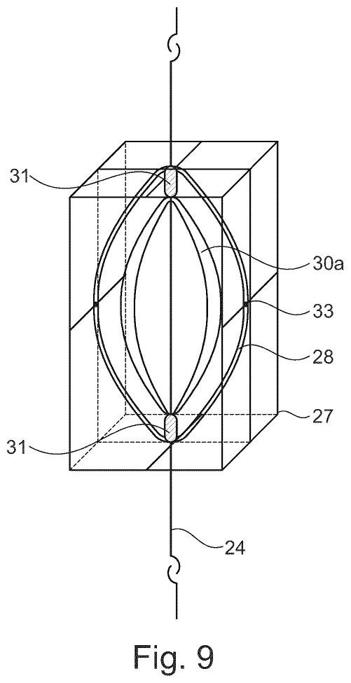

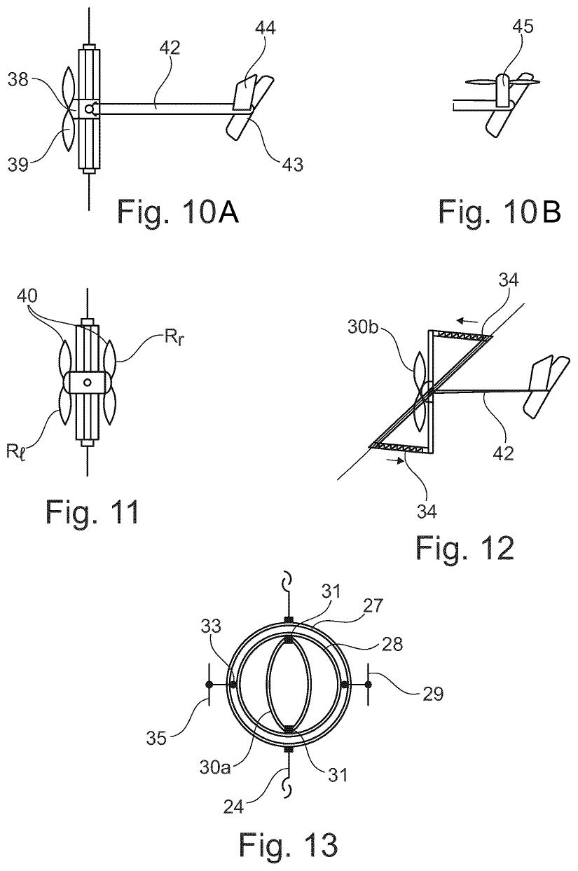

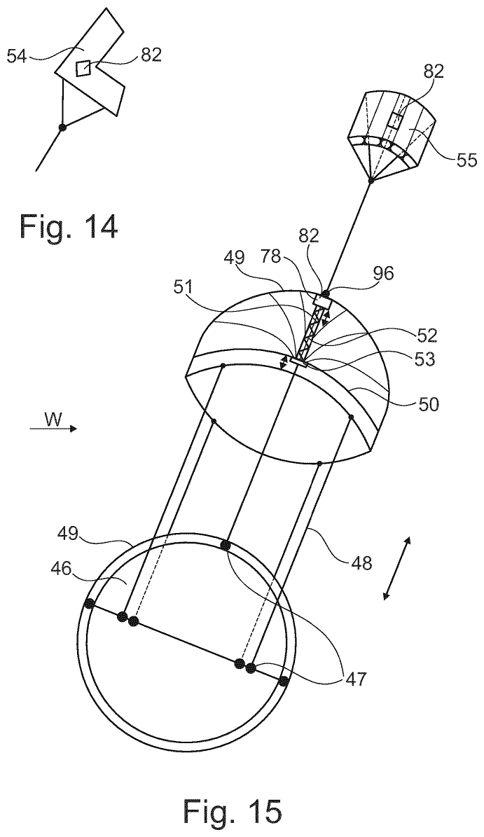

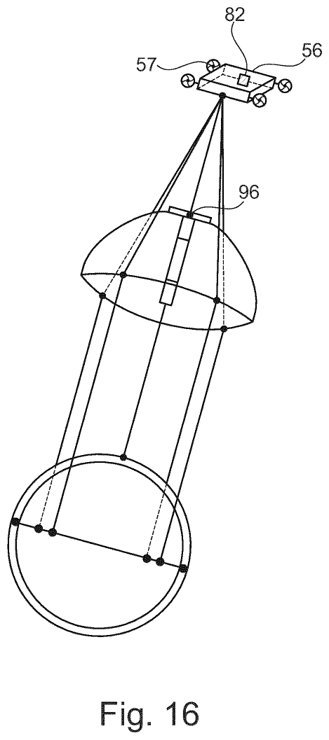

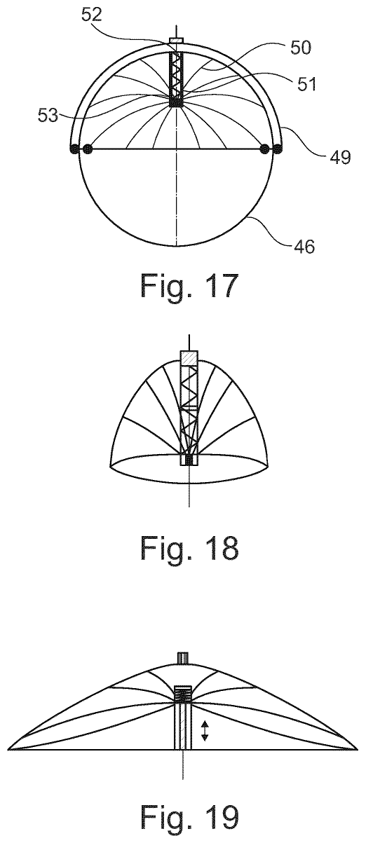

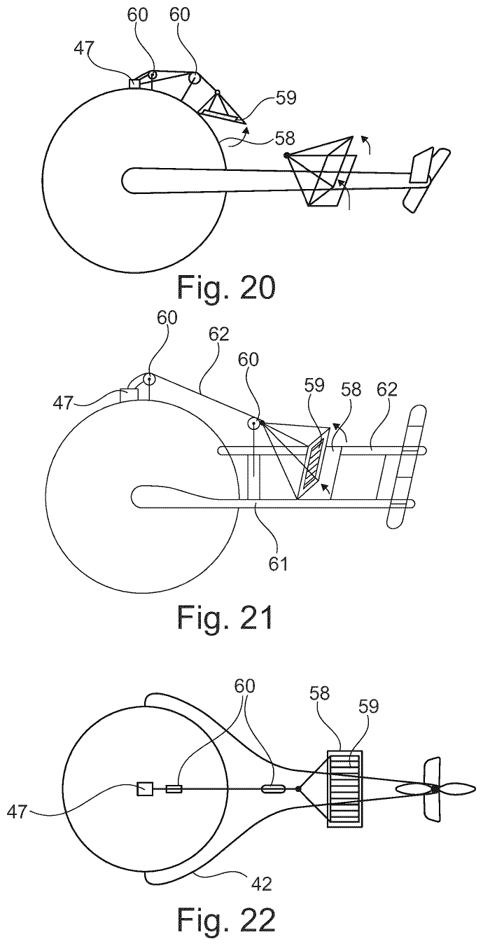

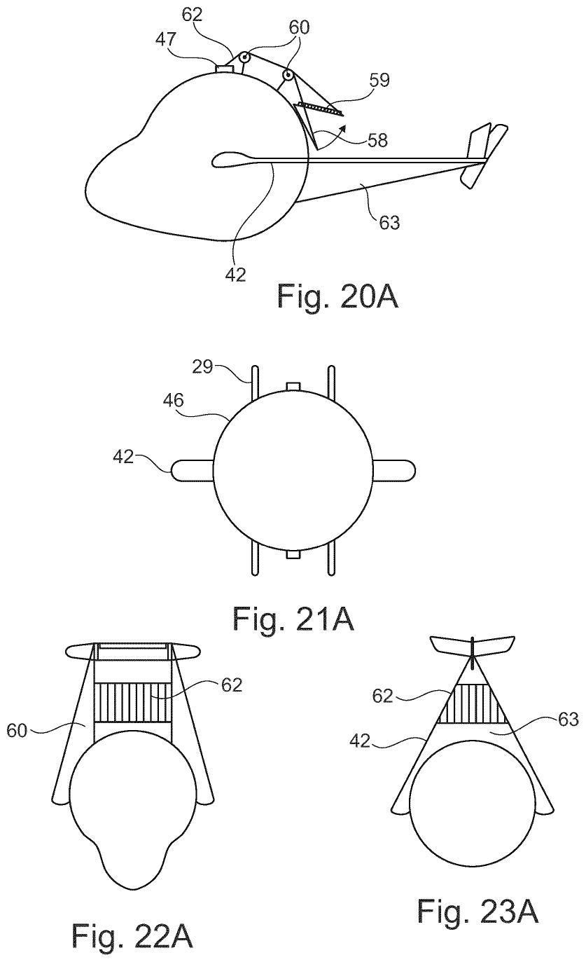

FIG. 20 demonstrates an alternative embodiment in that, instead of the preferred tandem variant consisting of, for example, The folding kite 59 is located on a kite carrier 58, which is positioned directly on the ascending balloon in its wind shadow and which is connected directly to the ascending balloon in its wind shadow and which is connected to the traction kite by means of a sensor and computer-controlled cable winch 47, which is fed by the secondary circuit, a directly adjoining deflection roller 60 and a second deflection roller 60, which is positioned directly on the other side, is positioned higher than the first deflection roller, as well as the second deflection roller 60 which is directly connected to the pull cables 62. The initiation of the starting process of the pulling kite is carried out in that, in the first step, the movable kite luggage carrier 58, which is situated optimally in the wind shadow and which is drawn through the pulling cables as the first into the inclined position (type of starting ramp), is thus activated Draw drafts an ideal starting position in order then to lift off with a powerful pull on the holding cables.

In addition to FIG. 20, FIG. 21 shows the placement of the kite carrier 58 together with folded draw kite 59, which is positioned on an installed double tail unit 61 preferably in the wind shadow region of the airship and upstream deflection roller 60.

In addition to the bird's eye view, FIG. 22 shows the positioning of the folded-together pull kite 59 and the kite luggage carrier 58 as well as the lower deflection roller 60 on an installed, simple guide mechanism 42.

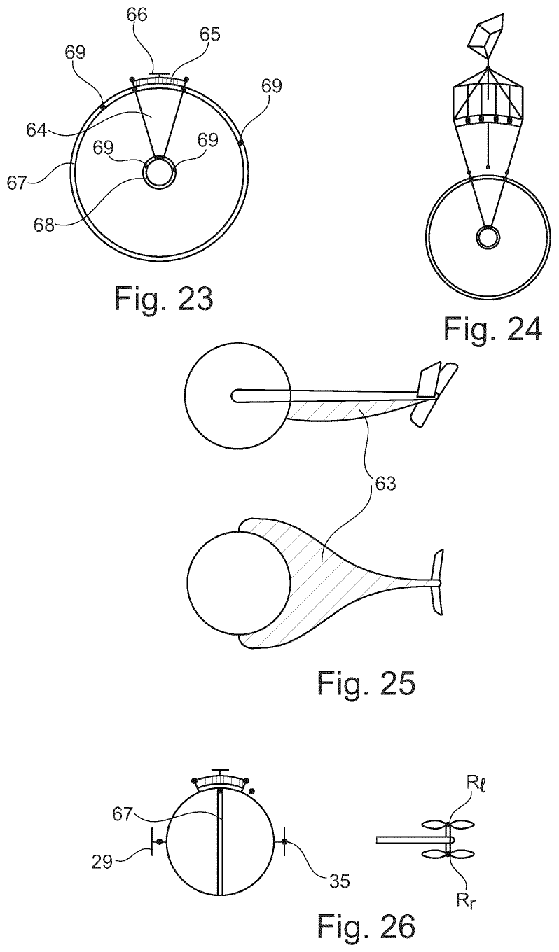

FIG. 23 shows, in a schematic representation of an alternative, here inactive pull kite holder together with folded draw kite 59, which is mounted on a movable trigger 64, which is mobile by means of an intermediate rail 67 located on the airship and by the axial guide rails 68 positioned on the right and left sides of the airship, respectively; the movable trigger visor can only move between the fixedly anchored position stoppers 69, wherein the distance is to be oriented at the maximum deflection of the GK. Furthermore, a kite is also fastened on the traction kite, which, together with the traction kite, again forms a flight tandem, in particular in the flight initiation phase.

In addition to FIG. 23, FIG. 24 shows a schematic representation of an activated flight tandemas, i.e. the rather efficient, self-flying kite first optimally pulls the trigger 64 into the wind as a second, pulls the pull kite into the optimum lift position, and then the kite, as already described, is completely separated from the traction kite and then falls back to the ground station or on the ground with the aid of the brake parachute 82 attached to the kite and then activated.

FIG. 25 schematically shows a simple guide mechanism 42 as well as a double tail unit 61, which additionally have a gas-filled chamber filled in the middle part, in order not to reduce the generated buoyancy force available to the GK as a whole, because each component is automatically pulled downward by gravity and is diametrically opposed to the buoyancy force.

In addition to FIG. 23, FIG. 26 shows the central central rail 67, which is necessary for guiding the movable trigger visor.

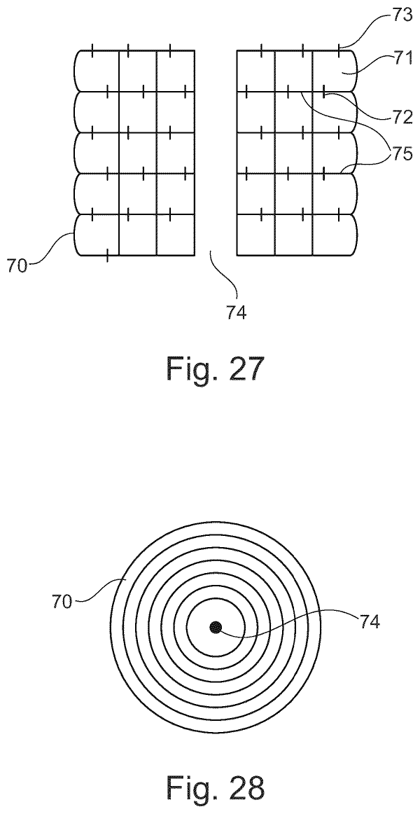

FIG. 27 schematically shows the cross section of the stable safety hoses 70 located in the flying unit, which, in order to prevent an emergency risk present latently, preferably still via separated gas chambers (segments) 71, which is preferably constructed according to a “Honeycomb structure”; In addition, each gas chamber for regulating the gas pressure has an inlet/outlet valve, a pressure sensor for adjusting the desired and actual pressure, and a gas supply network which fills the individual gas chambers via a liquid gas tank; the individual safety hoses 70 are mounted centrally around the central axis 74 of the flight unit and are fastened to one another and for the protection thereof the robust outer shell of the airship is tensioned.

Preferably, each airship embodiment should have a lightweight and very stable type of lattice frame structure to prevent deformation caused by the strong wind. The safety hoses are protected from the prevailing weather condition by the robust outer skin 97 of the airship, preferably structured in the manner of shark skin.

FIG. 28 shows in addition the safety hoses 70 stacked one on top of the other, which are arranged around the central axis 74 of the airship from the bird's eye view.

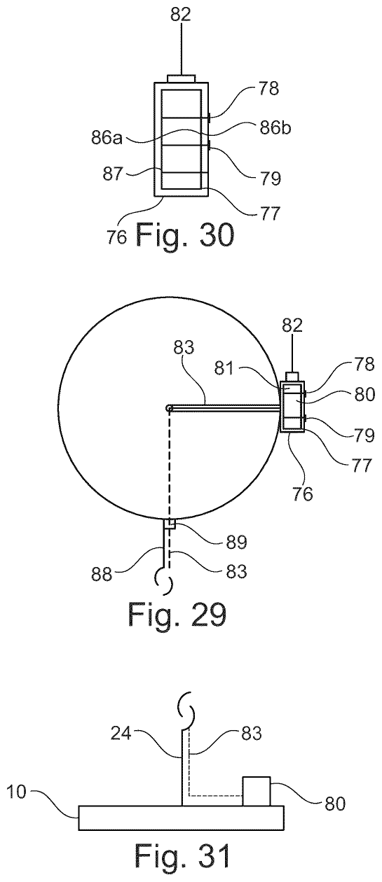

FIG. 29 shows a schematic view of the gas-filled airship with an installed holding box 76 located in the wind shadow and an integrated safety capsule 77, in which the resistant and stable liquid gas tank 80, which can be filled at any time from the outside, as well as preferably within the safety cell, gas evaporation unit 81 and a gas line 83 extending to the gas supply network 75 of the airship as well as the very robust retaining straps which run past the safety cell and have an integrated safety holding lock 79 and preferably those directly on the holding lock Mounted compressed-air-filled explosive capsules and or electromagnetic clutch 78, in order to separate the safety cell together with the hazardous liquid gas tank from the airship in an emergency situation (fall scenario), and with the integrated brake parachute 82 and the/those in the ground, preferably on the entire outer skin, of the safety cell a plurality of sensor- and computer-controlled, at least one airbag/s 88, which thus inflate the safety cell with the aid of the entrained compressed-air-filled propellant charge, and with a preferably battery-operated control unit or purely mechanically triggering gas discharge valves which are located in the outer casing of the airbag(s) and which thus do not strike the safety cell and are reliably brought to the ground, and an additional damping effect is produced by the valves if the safety cell were bump on the ground by the impact.

FIG. 30 shows an alternative gas supply by taking along a water-filled safety tank 87, a water pump 84 and an electrolyzer 86, a gas pressure pump, which receives the hydrogen generated by the electrolyzer, which receives its current through the power line located in the holding cable 88 and direct connection to the secondary circuit of the generator, which is fed through the gas line 83 directly into the gas supply network 75 installed in the airship.

FIG. 31 shows an additional alternative of the gas supply with the aid of a liquid gas tank, gas line, gas high-pressure pump located on the ground station, so that the line cross-section can be kept very small and thus reduce the latent danger potential to a minimum, since in an emergency situation and an undesired separation of the gas line the gas supply is stopped immediately and if gas in the line should be present at this moment, the gas quantity would not represent a great danger for the overall construction; It is provided here that the gas line extends only to fill possible gas chambers if the control unit installed in the GK detects a gas loss and automatically sets the filling process and, in the majority of the remaining time, the gas line remains unfilled and with an installed gas high-pressure pump this specification can be fulfilled and desirable. The gasification unit on board the airship is intended to include Liquid gas for the actual filling of the gas chambers can be converted from the aggregate state “liquid” to “gaseous” in a risk-free manner as required. The gas filling during a maintenance work to be carried out takes place age-natively and thus directly via the gas filling nozzle for refueling the airship 89, which is located directly on the airship.

As an additional embodiment alternative, a line-capable accumulator 86b, which is permanently charged by the secondary current circuit, can also be located in the fuse capsule 77 in order to carry out the overall system or its assemblies in an emergency situation (e.g.: fall-off situation and total failure of the secondary circuit) and, as a result, failure (residual risk) of the on-board safety architecture (for example: various control devices, brake parachute, etc.) in any position can safely supply power, and if the direct current generated should cause problems with regard to compatibility with the consumers to be supplied, a transformer is to transform the direct current generated by the generator into alternating current.

### LIST OF REFERENCE SIGNS

GK Overall construction
W Wind
H-GWKA High Wind Wind Turbine
WKA Wind power plant
WK wind converter/wheel
LU airship
BG assembly
RI rotor axis of rotation to the left
Rr rotor axis of rotation to the right
Smart sensor- and software-assisted, algorithm-based, current-dependent control unit

### I Soil Station

10 Bottom plate

### II Rotary Disc

12 Steerable wheels
13 Height-adjustable independent wheel suspension
14 Anchor piles
15 Thread and drill head
16 Rocking construction
17 Plant Safety Chamber/Maintenance Box
18 Support Support Safety Chamber
19 Pivoting device
20 Large cable drum
21 Quick-action winding motors
Safety cell with an angle-adjustable airbag construction at the upper end
23 Spring-damper unit
24 Holding cable, preferably with an integrated electrical conductor
25 Pivotable telescopic arms
26 Position holding ropes

### II Wind Converter/Wind Wheel Unit

27 External construction
28 Internal construction
29 Aileron
30 a Darius rotor
30 b Rotor blade converter
31 Generator and Transmission Unit
32 Anchor weight
33 cardanic suspension
34 Telescopic arms
35 Control Unit Rudder
36 Connecting struts
37 Connecting segment
38 horizontal wind converter
39 Rotor unit with rotor blade/blades
40 TWIN ROTOR UNIT
41 Structural side arms
42 Simple guide mechanism
43 elevator
44 Aileron
45 a Horizontal propeller unit
45 b Conductor cable

### III Airship

Gas-filled riser balloon/zeplin (keel airship/impingement airship) with integrated lattice tube frame
47 Rope winches
48 Tethers
49 Flight screen
50 Exo-skeleton
51 Cylinder control unit
52 Spring/damper element
53 stamp
54 Flight initiation kite
55 Flight initiation kite
56 Flight initiation drone
57 Sideprobs (fan units)

### IV Primary Tensile Kite

58 Pull-kite luggage carrier
59 Folded draw kite
60 Deflection roller
61 Double tail unit
62 Traction cables
63 Gas-filled chamber
64 Movable trigger visor
65 Draw kite
66 Kitte
67 Middle rail
68 Axial guide rail
69 Position stopper

### V Integrated Airship Safety Hose Elements

70 Safety hose
71 Gas chambers
72 Inlet and outlet valves
73 Pressure sensors
74 Central axis
75 Gas supply network

### VI Gas Supply Unit

76 Holding box
77 Safety capsule
78 Compressed-air-filled explosive capsules and/or electromagnetic couplings
79 Safety belt and closure
80 Liquid gas tank
81 Gasification device
82 Brake parachute
83 Gas line
84 Water line
85 a water pump
85 b Gas pressure distribution unit
a Electrolyzer
b accumulator (preferably lithium ions)
86 Water tank
87 Holding cable with power cable for the current secondary circuit
88 Gas filler neck for refueling the airship
89 Telescopic support
90 Cable drums or cable winches
91 Support column
92 Countersunk nose
93 Runner
94 Tensioning device
95 Separation Device Holding Cable
96 robust, shark skin-like structured outer skin

1. Wind turbine (WKA), comprising:
a base station (1),
a tether (24),
a wind converter (WK) and
an airship (LU);
wherein the airship (LU) is connected to a base plate (10) of the ground station (1) via the tether (24);
wherein the wind converter (WK) has a rotor (30) and a generator (31) connected to the rotor (30);
wherein the airship (LU) has a flight-initiation apparatus, and wherein the wind converter (WK) is arranged on the holding cable (24) in the region between the base plate (10) and the airship (LU), preferably below the airship (LU), characterized in that the wind turbine (WKA) further comprises a safety and securing device which is integrated in the region starting from the base plate (10) up to the airship (LU).

2. Wind power plant (WKA) according to claim 1, characterized in that the base plate (10) comprises a rotary disc (11) which is rotatably mounted relative to the base plate (10), wherein a plant safety chamber (17) is located on the rotary disc (11), in which installation safety chamber a safety cell (22) is integrated which is equipped with a spring-damper device (23).

3. Wind turbine (WKA) according to claim 1, wherein the ground station (1) further comprises at least one controllable airbag device (22a), wherein the airbag device (22a) is preferably arranged in the region of an upper end of the safety cell (22).

4. Wind power plant (WKA) according to claim 2, characterized in that the installation safety chamber (17) further comprises a large cable drum (20) which is driven by at least one quick-action motor (19) which is preferably located on the right and/or left side of the Large cable drum (20) is located, wherein the at least one fast running motor (19) is designed to wind the holding cable (24) onto the large cable drum (20) at a high rotational speed.

5. Wind turbine (WKA) according to claim 1, characterized in that the tether (24) comprises an integrated electrical conductor (24a).

6. Wind power plant (WKA) according to claim 2, characterized in that the installation safety chamber (17) is mounted so as to be pivotable relative to the rotary disc (10), for this purpose the installation safety chamber (17) is preferably suspended at the lower end in a movable rocking structure and is particularly preferably additionally attached to a pivoting device (19) of the installation safety chamber (17) so as to be movable in addition via a holding carrier (18) of the rotary disc (11) in order to support the orientability.

7. Wind power plant (WKA) according to claim 2, characterized in that in addition pivotable telescopic arms (25) are arranged on the rotary disc (11), which telescopic arms are preferably positioned at 180 degrees to one another and to the left and right of the installation safety chamber (17), to which in each case a position-holding cable (26) is connected via a respective high-power cable drum (90), which position-holding rope (26) is fastened directly to an outer structure (27) of the rotor (30).

8. Wind power plant (WKA) according to claim 7, characterized in that the high-power cable drums (90) are not responsible for the vertical movement of the wind converter (WK), but rather are designed to provide an additional deceleration function for the wind converter (WK) in a fall scenario.

9. Wind power plant (WKA) according to claim 1, characterized in that the base plate (10) is designed to be movable, by means of vertically movable individual wheel suspensions (13) installed on the base plate (10) and controllable wheels (12) fastened to the individual wheel suspension (13).

10. Wind power plant (WKA) according to claim 1, characterized in that several, preferably four, automatically acting anchoring piles (14) are arranged on the base plate (10), which anchoring piles are designed to anchor the base plate (10) in the ground, wherein the anchoring piles (14) are preferably each provided with a thread and drill head (15) and are fastened on the base plate 10.

11. Wind power plant (WKA) according to claim 1, characterized in that the wind converter (WK) comprises a vertical (e.g. Dareus rotor 30a) or a horizontal rotor (30) designed as a wind wheel which is suspended on a structure of the wind converter (WK), wherein the structure of the wind converter (WK) is preferably constructed from an outer structure (27) and an inner structure (28) and in the center of which the rotor (30) is suspended cardanically between the outer and inner structures (27, 28).

12. Wind power plant (WKA) according to claim 11, characterized in that at the lower end of the inner structure (27) the tether (24) is connected in a load-bearing manner to the wind converter (WK) via compressed-air-filled explosive capsules or an electromagnetic clutch (78), wherein an anchor weight (32) and/or a brake parachute (82) is preferably arranged at the lower end of the inner structure (27).

13. Wind turbine (WKA) according to claim 11, characterized in that preferably telescopic arms (34) are arranged between the outer structure (27) and the inner structure (28).

14. Wind power plant (WKA) according to claim 11, characterized in that compressed-air-filled explosive capsules or an electromagnetic clutch (78) and/or in each case one brake parachute are preferably located both at the lower end and at the upper end of the inner structure (28), on the outer side of which are positioned.

15. Wind power plant (WKA) according to claim 1, characterized in that the airship (LU) comprises a gas-filled balloon, preferably a rising balloon (46), on which a flight screen (49) is directly located, which is flying in the flight mode close to the gas-filled airship (46).

16. Wind power plant according to claim 15, characterized in that the flight screen (49) is pulled upwards by a self-flying, small flight initiation apparatus, for example by a kite (54), a drone (56) or a kite (55), and in the starting phase the orientation of the flight screen (49) is controlled by smart rope winches (47) which are arranged on the gas-filled balloon and wherein the flight screen (49) is connected via cables to the cable winches (47) and wherein the flight initiation apparatus is connected to the flight screen (49) via a cable (48).

17. Wind power plant according to claim 15, characterized in that an exo-skeleton (50) is arranged inside the flight screen (49), in that, after the starting phase, the flight screen (49) is expanded and relaxed with the integrated control unit (51).

18. Wind power plant according to claim 15, characterized in that the flight initiation apparatus comprises a brake parachute (82), which is preferably triggered prior to the separation of the flight initiation apparatus, with the aid of a separating device (96) arranged on the cable (48), wherein the brake parachute (82) is arranged at an upper dead center of the flight screen (49).

19. Wind power plant according to claim 18, characterized in that a compressed-air-filled explosive capsule or an electromagnetic clutch (78) is arranged as a separating device (96) at the top dead center of the flight screen (49).

20. Wind power plant according to claim 1, characterized in that safety hoses (70) which can be tightened in the interior of the airship (LU) are installed, which in turn comprise a plurality of gas chambers (71) and which each have inlet and outlet valves (72) and pressure sensors which are supplied by the on-board gas supply network (75) which runs between the safety hoses (70) and which are protected from the outside by the robust outer skin (97) of the airship (LU), which is preferably structured in the manner of a shark skin.

21. Wind power plant according to claim 20, characterized in that a holding box (76) is mounted on the airship (LU) in the wind shadow, having an integrated safety cell (77), in which preferably a liquid gas tank (80) with an inclusive gasification unit (81) and a gas line (83) is located, which is directly connected to the gas supply network (75), so that the gas supply of the safety hoses (70) and/or its individual gas chambers (71) can thereby take place.

22. Wind power plant according to claim 21, characterized in that an electrolyzer (86a) for generating hydrogen, a water tank (87), a water pump and a gas pressure distributor unit for the generated hydrogen are alternatively contained in the safety cell (77).

23. Wind power plant according to claim 21, characterized in that an integrated accumulator (86b), preferably a lithium-ion battery, is arranged in the safety cell (77).

24. Wind power plant according to claim 21, characterized in that the safety cell (77) is fastened to the holding box (76) by at least one safety belt and at least one closure (79) and, in addition to the at least one closure, preferably at least one compressed-air-filled explosive capsule and/or an electromagnetic clutch (78) and a brake parachute (82) are arranged.
